(19) United States
(12) Patent Application Publication
(10) Pub. No.: US 2013/0024365 A1
(43) Pub. Date: Jan. 24, 2013

(54) Fee-Based Communications

(71) Applicant: Roy Schoenberg, Boston, MA (US)

(72) Inventor: Roy Schoenberg, Boston, MA (US)

(21) Appl. No.: 13/186,899

(22) Filed: Jul. 20, 2011

(51) Int. Cl. G06Q 30/00

(52) U.S. Cl. 705/40

(57) ABSTRACT

A computer-implemented method includes receiving, by a computer system, a service request; identifying by the computer system a type of the service request; retrieving, by the computer system, a mapping specifying one or more fee amounts to be charged for a plurality of types of service requests and one or more types of service providers qualified to respond to the plurality of types of service requests; retrieving, based the identified type of service request and the mapping, a fee amount for the service request and a type of service provider qualified to respond to the service request; and processing payment information for the determined fee amount.

### BACKGROUND

Systems have been developed to provide services that connect consumers and their providers over the Internet and the World Wide Web. Some systems use e-mail messaging and web-based forms to increase the level of connectivity between a member of a health plan and his assigned health care provider. The consumer sends an e-mail or goes to a website that generates and sends a message (typically an e-mail or an e-mail type message) to a local provider.

These types of services have been broadly referred to as “e-visits.” While generally viewed as an addition to the spectrum of services that may be desired by consumers, the benefits of such services are not clear. One of the concerns associated with offering additional communication channels, such as e-mail, is that it can result in over consumption of services, rather than provide for better coordination.

Another system is a brokerage type of system as described in my issued Patent U.S. Pat. No. 7,590,550, which is incorporated herein by reference.

### SUMMARY

In one aspect of the present disclosure, a computer-implemented method includes receiving, by a computer system, a service request; identifying by the computer system a type of the service request; retrieving, by the computer system, a mapping specifying one or more fee amounts to be charged for a plurality of types of service requests and one or more types of service providers qualified to respond to the plurality of types of service requests; retrieving, based the identified type of service request and the mapping, a fee amount for the service request and a type of service provider qualified to respond to the service request; and processing payment information for the determined fee amount.

Implementations of the disclosure may include one or more of the following features. In some implementations, the method includes receiving from a computer system that sent the service request the payment information for the determined fee amount. In other implementations, the method includes receiving from a computer system used by the qualified type of service provider a response message to the service request. In still other implementations, the response message includes at least one of the one or more system records.

In some implementations, the method includes sending the response message to a computing device that sent the service request. In other implementations, the method includes determining, at least partly based on contents of the service request, an identity of a consumer using a computer system that sent the service request. In still other implementations, the method includes retrieving one or more system records pertaining to the service request; and sending to a computer system used by the qualified type of service provider the one or more system records and the service request.

In another aspect of the disclosure, a computer program product is tangibly stored on a computer readable storage media, the computer program product includes instructions for causing a processor to: receive a service request; identify a type of the service request; retrieve a mapping specifying one or more fee amounts to be charged for a plurality of types of service requests and one or more types of service providers qualified to respond to the plurality of types of service requests; retrieve, based the identified type of service request and the mapping, a fee amount for the service request and a type of service provider qualified to respond to the service request; and process payment information for the determined fee amount. Implementations of this aspect of the present disclosure may include one or more of the foregoing features.

In still another aspect of the disclosure, an electronic systems includes a processor and a computer program product tangibly stored on a computer readable storage media, the computer program product includes instructions for causing the processor to: receive a service request; identify a type of the service request; retrieve a mapping specifying one or more fee amounts to be charged for a plurality of types of service requests and one or more types of service providers qualified to respond to the plurality of types of service requests; retrieve, based the identified type of service request and the mapping, a fee amount for the service request and a type of service provider qualified to respond to the service request; and process payment information for the determined fee amount. Implementations of this aspect of the present disclosure may include one or more of the foregoing features.

### BRIEF DESCRIPTION OF THE FIGURES

FIG. 1 shows an example system for fee-based communications.

FIG. 2 is a sample mapping used by the system.

FIGS. 3-4 are flow charts of processes used in the system.

FIGS. 5, 6, 7 are example graphical user interfaces generated by the system.

FIG. 8 is a block diagram of a computer (computer system) showing exemplary components that can be used for the brokerage system and/or client systems.

### DETAILED DESCRIPTION

The system described below provides a platform for fee-based communication between a service provider and a consumer. Through the system, a consumer submits a service request. For example, the service request may be for information included in a medical record of the consumer. Using contents of the service request, the system determines the type of requested information, including, e.g., copies of physician referrals, copies of lab reports, copies of X-ray reports, consumer's questions, and so forth. Based on the type of service request, the system accesses a fee schedule and determines an appropriate amount to charge the consumer for a service provider's response to the service request. Additionally, the system forwards the service request to a service provider that is appropriate to respond to the service request. Through the service request and a response to the service request, the consumer engages in an asynchronous communication with the service provider.

To assist the service provider in responding to the service request, the system parses the service request to determine identifying information for the consumer sending the service request. Using the identifying information, the system accesses system records for the consumer (e.g., physician referrals, lab reports, X-ray reports, and so forth). Using the type of requested information, the system selects system records of the requested type of information and sends the selected system records for the service provider to review and/or to re-send to the consumer.

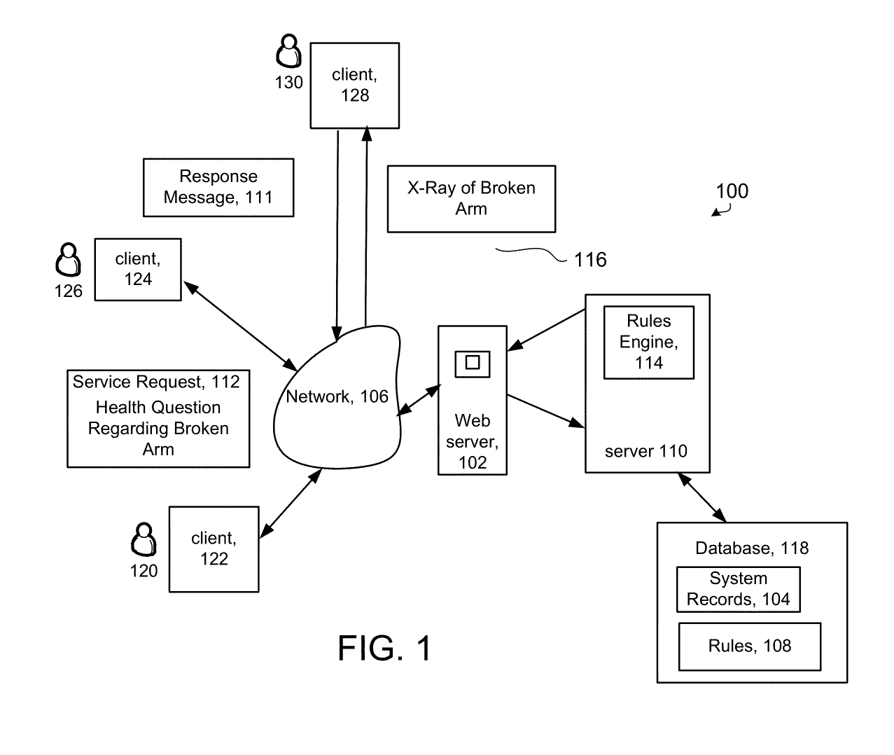

FIG. 1 shows an example system 100 implementing a service for fee-based communications. System 100 includes a computerized system or server 110 for making connections between consumers 120, 126, at client devices 122, 124, and service providers 130, at client devices 128, over a network 106, e.g., the Internet or other types of networks. Server 110 may operate as a service running on web server 102.

Server 110 includes rules engine 114. Rules engine 114 is configured to execute one or more rules specifying a fee for numerous types of communication. System 100 also includes database 118. Database 118 includes system records 104. System records 104 include medical records for consumers 120, 126. For example, system records 104 include lab results, referrals to physicians, x-rays, diagnostic information, physician notes and other information pertaining to medical records for consumers 120, 126. Database 118 also includes rules 108 for determining a fee to be applied for a response (e.g., response message 111) to service request 112.

Client device 124 sends service request 112 to server 110 through network 106. Service request 112 includes a request for service provider 130 to review an x-ray regarding a broken arm of consumer 126. Server 110 receives service request 112. Server 110 parses service request 112 to determine an identity of consumer 126 that sent service request 112 and also to identify a type of service request 112. Using the parsed information, server 110 identifies that service request 112 pertains to a broken arm of consumer 126.

Server 110 queries database 118 for information associated with consumer 126. Data in system records 104 is tagged with information specifying an identity of various consumers. System records 104 include x-ray record 116, which is an x-ray of the broken arm of consumer 126. X-ray record 116 is stored in database 118 with a tag associating x-ray record 116 with consumer 126. Using the tagged information, database 118 determines a correspondence between the consumer identity information included in service request 112 and the tag associated with x-ray record 116.

Database 118 sends x-ray record 116 to server 110, which in turn sends x-ray record 116 to client device 128 to promote an ability of service provider 130 to address service request 112. Server 110 also generates a notification of service request 112 and sends the notification to client device 128, for example, with x-ray-record 116.

Service provider 130 views x-ray record 116 on client device 128. Based on an analysis of x-ray record 116, service provider 130 provides a response to service request 112 by inputting response information into client device 128. Using the input response information, client device 128 generates response message 111, which is sent to server 110. Response message 111 includes a response by service provider 130 to service request 112. For example, service request 112 includes a question regarding the broken arm of consumer 126. Using x-ray record 116, service provider 130 answers the consumer's question in response message 111.

Service provider 130 attaches x-ray record 116 to response message 111, for example, to provide consumer 126 with a copy of x-ray record 116. Server 110 receives response message 111 and sends response message to client device 124 used by consumer 126. Through client device 124, consumer 126 views response message 111 including, for example, the contents of response message 111 and/or x-ray record 116.

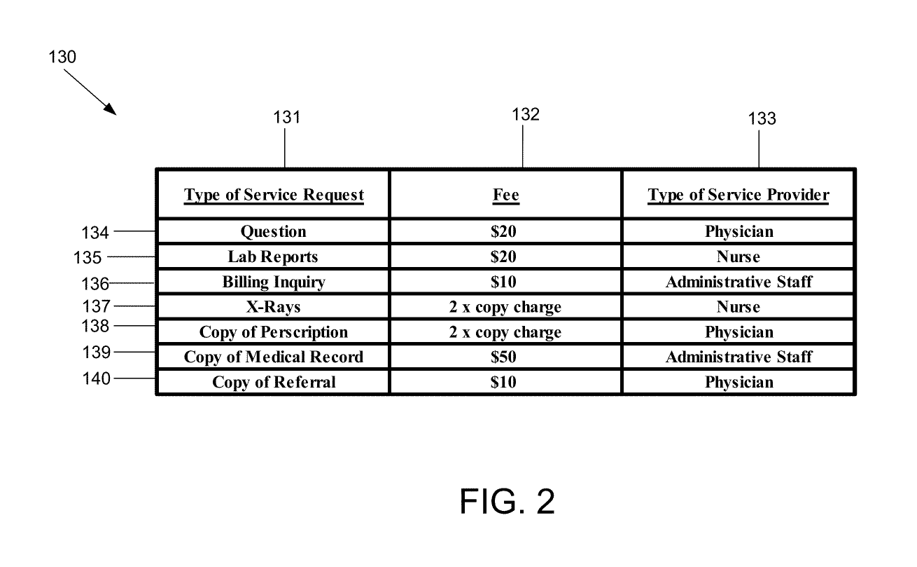

Server 110 also determines a fee amount to be charged to consumer 126 for service provider 130 to address service request 112. To determine an appropriate fee amount for service request 112, server 110 access rules 108 stored in database 118. Rules 108 include one or more instructions specifying a fee amount for numerous, different types of service requests, as described in further detail with regard to FIG. 2. Rules engine 114 executes rules 108 and determines a fee amount for service request 112.

Server 110 generates a message (not shown) that includes information indicative of the fee amount for service request 112. Server 110 sends this message to client device 124. Through client device 124, consumer 126 views this message. Consumer 126 accepts the fee amount, for example, by entering credit card information into a graphical user interface rendered on client device 124. Using the entered credit card information, server 110 charges consumer 126 for the response to service request 112. If consumer 126 does not accept the fee amount, consumer 126 sends server 110 a message to abort service request 112.

Referring to FIG. 2, an example mapping 130 among types of service requests, fee amounts, and types of service providers is shown. Rules 108 (FIG. 1) include mapping 130. Mapping 130 includes information 131 specifying a type of service request, information 132 specifying a fee amount for a type of service request, and information 133 specifying a type of service provider qualified to provide a response for a type of service request.

Mapping 130 also includes entries 134-140. Entry 134 includes information specifying that when the type of service request is a health question, the fee amount is $20.00 and the type of service provider qualified to provide a response to the health question service request is a physician. Entry 135 provides information specifying that when the type of service request is a lab report that the fee amount is $20.00 and the type of service provider qualified to respond to the lab report service request is a nurse.

Entry 136 specifies that when the type of service request is a billing inquiry the fee amount is $10.00 and the type of service provider qualified to respond to the billing inquiry service request is administrative staff. Entry 137 specifies that when the type of service request is an x-ray that the fee amount is twice a copy charge. A copy charge includes an amount that a medical office and/or medical facility incurs for a making a reproduction of a document. In entry 137, when the type of service request is an x-ray, the type of service provider qualified to respond to the service request is a nurse. Entry 138 includes information specifying that when the type of service request is a copy of a prescription that the fee amount is twice an amount of the copy charge and the type of service provider qualified to respond to the service request is a physician. Entry 139 includes information specifying that when the type of service request is a copy of a medical record that the fee amount is $50.00 and the type of service provider qualified to respond to the service request is administrative staff. Entry 140 includes information specifying that when the type of service request is a copy of a referral that the fee amount is $10.00 and that the type of service provider qualified to respond to the service request is a physician.

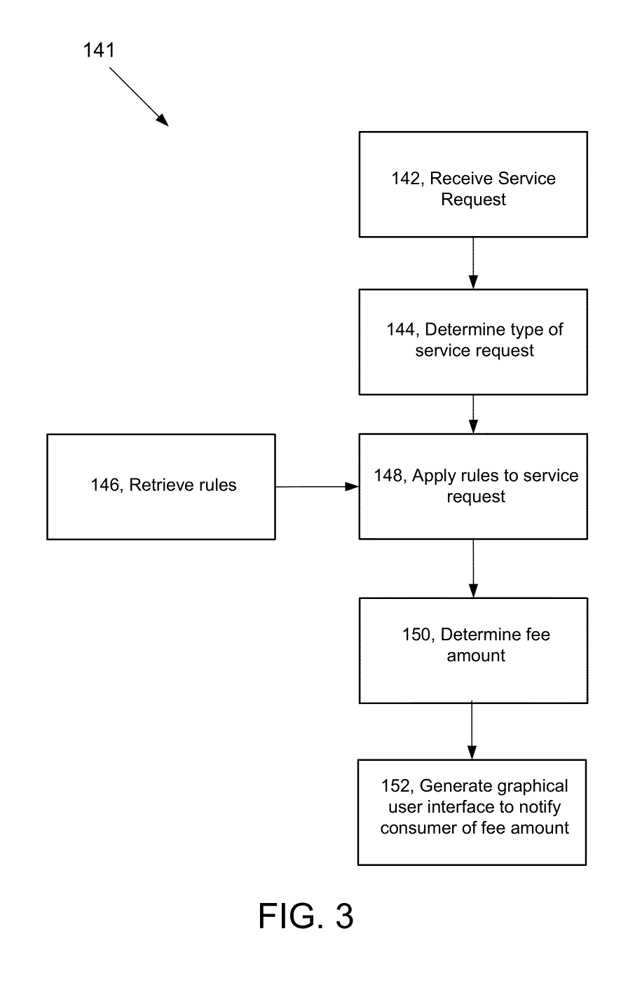

FIG. 3 is an example process 141 for using rules 108 in determining a fee amount for service request 112. In operation, server 110 receives (142) service request 112. Using contents of service request 112, server 110 determines (144) a type of service request 112. Server 110 retrieves (146) rules 108 from database 118. As previously described, rules 108 include mapping 130. Rules engine 114 applies (148) rules 108 to service request 112.

Rules engine 114 determines (150) a fee amount, for example, based on application of rules 108 to service request 112. For example, server 110 parses service request 112 to determine that the type of service request is a question. Server 110 determines that the type of service request for service request 112 is a question because service request 112 includes the word “question.” Rules engine 114 executes rules 108, including mapping 130, and identifies entry 134 in mapping 130 as pertaining to a type of service request for questions. Rules engine 114 determines that the fee amount for a question is $20.00 and that the type of service provider qualified to answer a question is a physician, e.g., service provider 130. Rules engine 114 generates a message (not shown) notifying consumer 126 that a response to service request 112 costs $20.00.

Server 110 generates (152) a graphical user interface to display the message and to notify consumer 126 of the fee amount for service request 112. For example, the graphical user interface may include a webpage that when rendered on client device 124 renders the visual representation of the fee amount and prompts consumer 126 to enter into the graphical user interface payment information including, for example, credit card information.

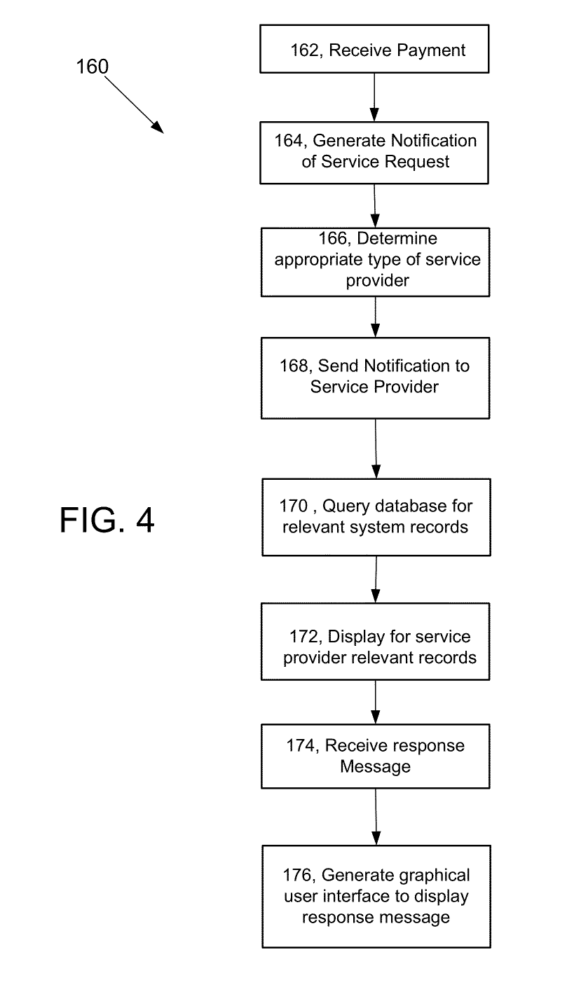

FIG. 4 includes an example process 160 for generating response message 111 to service request 112. In operation, server 110 receives (162) from client device 124 payment information for service request 112. Server 110 processes the payment information for service request 112, for example, by processing credit card information, debiting a bank account, generating an invoice, and so forth. Server 110 determines a portion of the fee amount to be credited to an account of service provider 130. For example, an entity running server 110 (e.g., the brokerage service) keeps a predetermined portion of the fee amount (e.g., 50% of the fee amount) and credits a bank account of service provider 130 for the remaining portion of the fee amount (e.g., the remaining 50%).

In response to payment for service request 112, server 110 generates (164) notification (not shown) of service request 112. The notification of service request 112 includes a message to notify service provider 130 about service request 112, for example, by notifying service provider 130 that service request 112 has been sent to an inbox of service provider 130. Rules engine 114 determines (166) an appropriate type of service provider to respond to service request 112. As previously described, rules engine 114 uses mapping 130 to determine an appropriate type of service, for example, based on the type of service request 112.

Server 110 sends (168) the notification of service request 112 to service provider 130. Server 110 is configured to retrieve from database 118 system records 104 pertaining to the type of service request and also tagged with information corresponding to the identity of consumer 126. Server 110 is also configured to identify system records 104 that pertain to consumer 126 based on identifying information for consumer 126 that was included in service request 112, including, e.g., the name of consumer 126, login information for consumer 126 and/or other identifying information for consumer 126.

Using the identity of consumer 126, server 110 queries (170) database 118 for system records 104 associated with consumer 126 and relevant to service request 112. For example, service request 112 includes the words “broken arm.” Server 110 selects from system records 104 records that are tagged as pertaining to limbs and/or arms of consumer 126. Server 110 selects x-ray record 116 from database 118. Server 110 displays (172) x-ray record 116 for service provider 130, e.g., via client device 128 used by service provider 130.

Using the contents of service request 112 and x-ray record 116, service provider 130 generates response message 111. In particular, response message 111 includes textual and/or graphic information that is responsive to service request 112. Service provider 130 may decide to include in response message 111 x-ray record 116, for example, so that consumer 126 has a copy of x-ray record 116. Service provider sends response message 111 to server 110 through network 106. Server 110 receives (174) response message 111. In response, server 110 sends response message 111 to client device 124 that is used by consumer 126.

In another embodiment, server 110 generates (176) a graphical user interface that, when rendered on client device 124, renders a visual representation of response message 111. For example, when consumer 126 is provided with an online message box, for example an email inbox, server 110 is configured generate a graphical user interface that when rendered on client device 124 renders for consumer 126 the contents of response message 111 in the inbox.

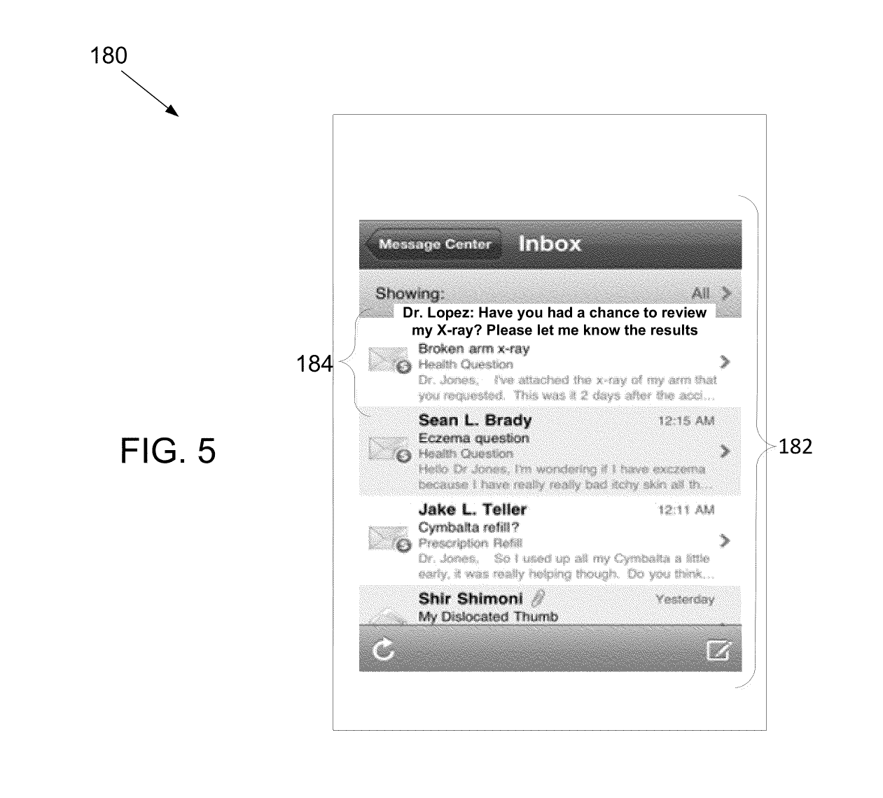

FIG. 5 is an example screen shot 180 of graphical user interface 182 generated by server 110 and rendered on a client device, including, e.g., client device 128. Graphical user interface 182 is part of an application generated by server 110. Client device 128 downloads the application onto client device 128 to access an inbox for service provider 130 via graphical user interface 182.

Graphical user interface 182 renders a visual representation of an electronic messaging inbox. Graphical user interface 182 includes portion 184 that displays the contents of service request 112 sent to service provider 130, namely, the question of “Dr. Lopez have you had a chance to review my x-rays? Please let me know the results.” Portion 184 of graphical user interface 182 is selectable, selection of which causes the contents of service request 112 to be displayed on client device 128.

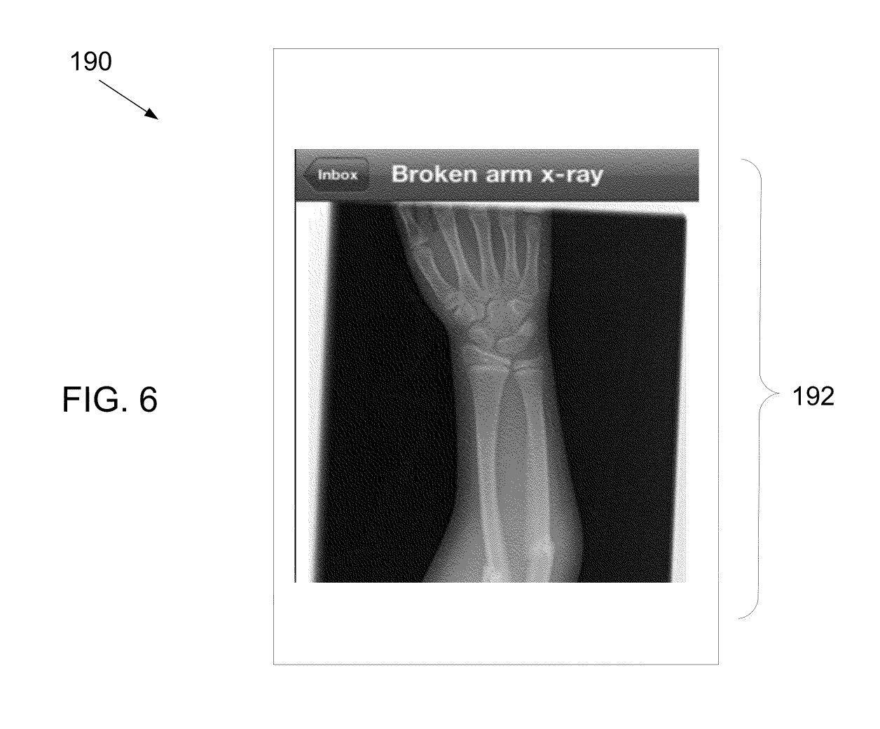

FIG. 6 is a screen shot 190 of graphical user interface 192 generated by server 110. Graphical user interface 192 includes a visual representation of x-ray record 116. In this example, FIG. 6 is an illustration of x-ray record 116 as viewed by service provider 130 on client device 128.

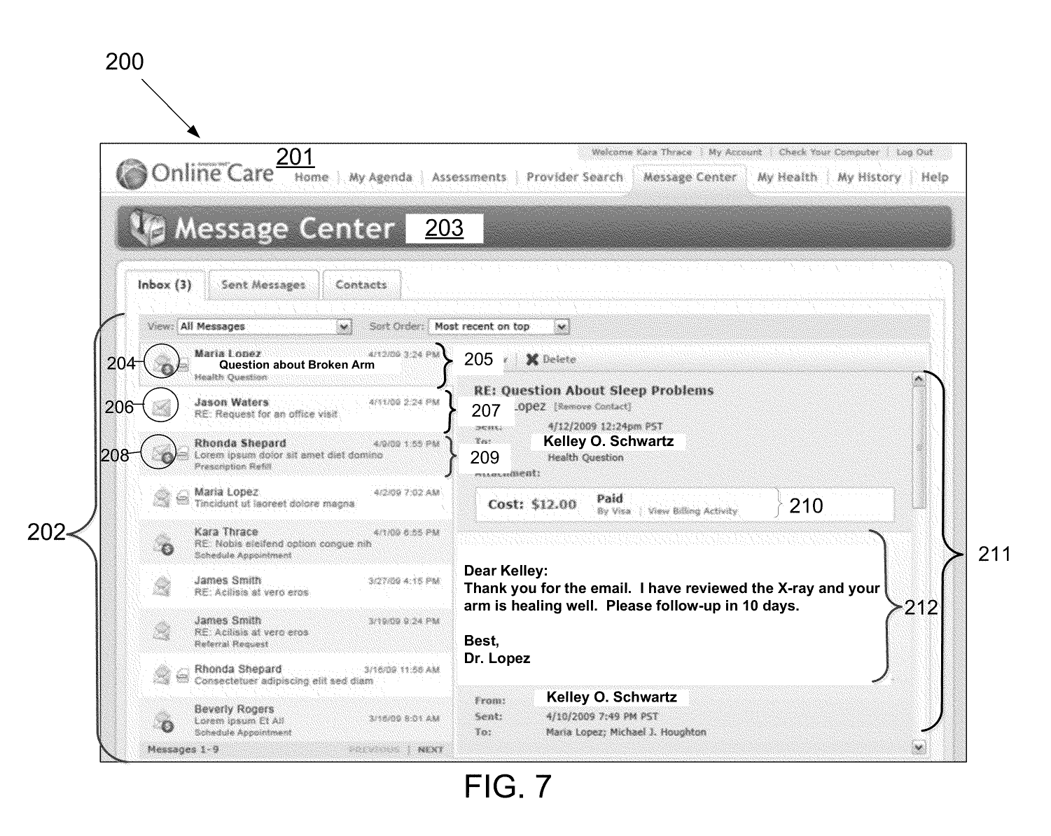

FIG. 7 is a screen shot 200 of graphical user interface 201 generated by server 110. When displayed on client device 124, graphical user interface 201 renders a visual representation of message center 203 for consumer 126. Message center 203 includes portion 202. Portion 202 of message center 203 includes a listing of numerous service requests that have been sent by client device 124 used by consumer 126 to server 110. For example, portion 202 of message center 203 includes visual representation 205 of service request 112. Visual representation 205 includes status indicator 204. Status indicator 204 includes information specifying the status of service request 112, including, for example, whether consumer 126 has paid for service request 112, whether service request 112 has been sent by consumer 126, and whether service provider 130 has opened service request 112 Status indicator 204 includes a dollar sign symbol to indicate that consumer 126 has paid for service request 112. Status indicator 204 also includes an open envelope image to indicate that service request 112 has been viewed by service provider 130.

Portion 202 also includes visual representations 207, 209 of other service requests. Visual representation 207 includes status indicator 206 with a closed envelope image to specify that the service request associated with visual representation 207 has been sent by consumer 126 but not opened by service provider 130. Additionally, an absence of the dollar sign symbol in status indicator 206 indicates that consumer 126 has not paid for the service request associated with visual representation 207.

Visual representation 209 of a service request includes status indicator 208. Status indicator 208 includes the dollar sign symbol indicating that the service request associated with visual representation 209 has been paid for by consumer 126. Status indicator 208 also includes the closed envelope image indicating that consumer 126 has sent the service request associated with visual representation 209 to server 110 but service provider 130 has not opened the service request associated with visual representation 209.

Graphical user interface 201 also includes portion 211 for consumer 126 to view the contents of response message 111. Portion 211 also includes visual representation 210 of the fee amount that consumer 126 was charged to receive response message 111. Portion 211 also includes visual representation 212 of the contents of response message 111, including an assessment responsive to the question included in service request 112.

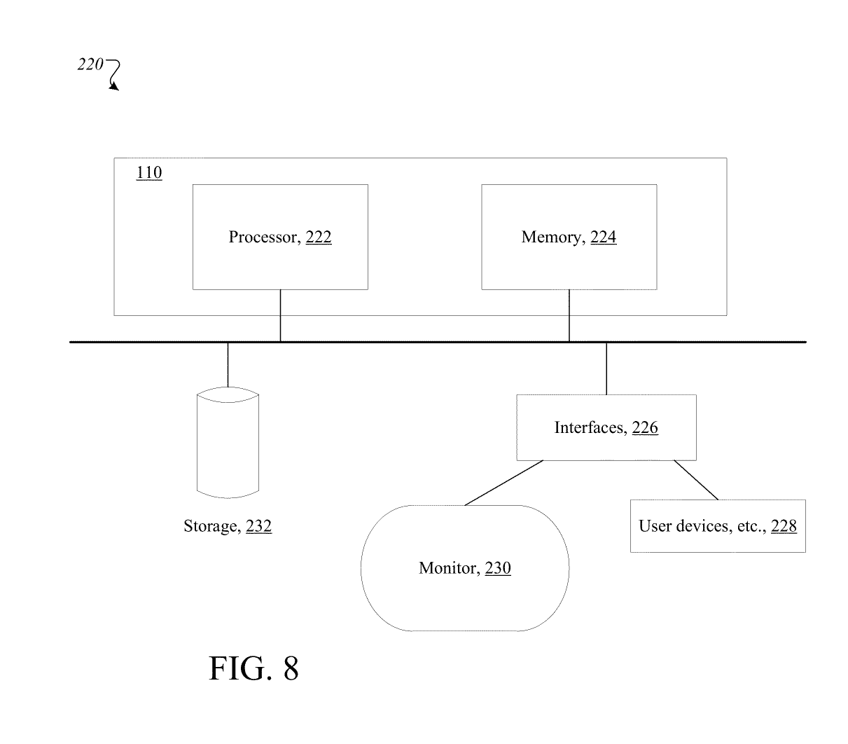

FIG. 8 is a block diagram of components 220 of the engagement brokerage system. User devices 228 can be any sort of computing device capable of taking input from a user and communicating over a network (not shown) with server 110 and/or with other client devices. For example, user device 228 can be a mobile device, a desktop computer, a laptop, a cell phone, a personal digital assistant (“PDA”), a server, an embedded computing system, a mobile device and so forth. User devices 228 include monitor 230, which renders visual representations of interface 226.

Server 110 can be any of a variety of computing devices capable of receiving information, such as a server, a distributed computing system, a desktop computer, a laptop, a cell phone, a rack-mounted server, and so forth. Server 110 may be a single server or a group of servers that are at a same location or at different locations.

Server 110 can receive information from user device 228 via interfaces 226, including, e.g., graphical user interfaces. Interfaces 226 can be any type of interface capable of receiving information over a network, such as an Ethernet interface, a wireless networking interface, a fiber-optic networking interface, a modem, and so forth. Server 110 also includes a processor 222 and memory 224. A bus system (not shown), including, for example, a data bus and a motherboard, can be used to establish and to control data communication between the components of server 110.

Processor 222 may include one or more microprocessors. Generally, processor 222 may include any appropriate processor and/or logic that is capable of receiving and storing data, and of communicating over a network (not shown). Memory 224 can include a hard drive and a random access memory storage device, such as a dynamic random access memory, machine-readable media, or other types of non-transitory machine-readable storage devices.

Components 220 also include storage device 232, which is configured to store information collected through the brokerage system during a service provider's consultation with a consumer.

Embodiments can be implemented in digital electronic circuitry, or in computer hardware, firmware, software, or in combinations thereof. Apparatus of the invention can be implemented in a computer program product tangibly embodied or stored in a machine-readable storage device and/or machine readable media for execution by a programmable processor; and method actions can be performed by a programmable processor executing a program of instructions to perform functions and operations of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Computer readable storage media are storage devices suitable for tangibly embodying computer program instructions and data include all forms of volatile memory such as RAM and non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Other embodiments are within the scope and spirit of the description claims. In an example, the brokerage services described herein may be applied to numerous, different types of service providers, including, e.g., medical professionals, physicians, nurses, and so forth. In another example, due to the nature of software, functions described above can be implemented using software, hardware, firmware, hardwiring, or combinations of any of these. Features implementing functions may also be physically located at various positions, including being distributed such that portions of functions are implemented at different physical locations.

What is claimed is:

1. A computer-implemented method comprising:
receiving, by a computer system, a service request;
identifying by the computer system a type of the service request;
retrieving, by the computer system, a mapping specifying one or more fee amounts to be charged for a plurality of types of service requests and one or more types of service providers qualified to respond to the plurality of types of service requests;
retrieving, based the identified type of service request and the mapping, a fee amount for the service request and a type of service provider qualified to respond to the service request; and
processing payment information for the determined fee amount.

2. The computer-implemented method of claim 1, further comprising:
receiving from a computer system that sent the service request the payment information for the determined fee amount.

3. The computer-implemented method of claim 1, further comprising:
receiving from a computer system used by the qualified type of service provider a response message to the service request.

4. The computer-implemented method of claim 3, wherein the response message includes at least one of the one or more system records.

5. The computer-implemented method of claim 3, further comprising:
sending the response message to a computing device that sent the service request.

6. The computer-implemented method of claim 1, further comprising:
determining, at least partly based on contents of the service request, an identity of a consumer using a computer system that sent the service request.

7. The computer-implemented method of claim 1, further comprising:
retrieving one or more system records pertaining to the service request; and
sending to a computer system used by the qualified type of service provider the one or more system records and the service request.

8. A computer program product tangibly stored on a computer readable storage media, the computer program product comprising instructions for causing a processor to:
receive a service request;
identify a type of the service request;
retrieve a mapping specifying one or more fee amounts to be charged for a plurality of types of service requests and one or more types of service providers qualified to respond to the plurality of types of service requests;
retrieve, based the identified type of service request and the mapping, a fee amount for the service request and a type of service provider qualified to respond to the service request; and
process payment information for the determined fee amount.

9. The computer program product of claim 8, wherein the computer program product further comprises instructions for causing the processor to:
receive from a computer system that sent the service request the payment information for the determined fee amount.

10. The computer program product of claim 8, wherein the computer program product further comprises instructions for causing the processor to:
receive from a computer system used by the qualified type of service provider a response message to the service request.

11. The computer program product of claim 10, wherein the response message includes at least one of the one or more system records.

12. The computer program product of claim 10, wherein the computer program product further comprises instructions for causing the processor to:
send the response message to a computer system that sent the service request.

13. The computer program product of claim 8, wherein the computer program product further comprises instructions for causing the processor to:
determine, at least partly based on contents of the service request, an identity of a consumer using a computer system that sent the service request.

14. The computer program product claim 8, wherein the computer program product further comprises instructions for causing the processor to:
retrieve one or more system records pertaining to the service request; and
send to a computer system used by the qualified type of service provider the one or more system records and the service request.

15. An electronic system comprising:
a processor; and
a computer program product tangibly stored on a computer readable storage media, the computer program product comprising instructions for causing the processor to:
receive a service request;
identify a type of the service request;
retrieve a mapping specifying one or more fee amounts to be charged for a plurality of types of service requests and one or more types of service providers qualified to respond to the plurality of types of service requests;
retrieve, based the identified type of service request and the mapping, a fee amount for the service request and a type of service provider qualified to respond to the service request; and
process payment information for the determined fee amount.

16. The electronic system of claim 15, wherein the computer program product further comprises instructions for causing the processor to:
receive from a computer system that sent the service request the payment information for the determined fee amount.

17. The electronic system of claim 15, wherein the computer program product further comprises instructions for causing the processor to:
receive from a computer system used by the qualified type of service provider a response message to the service request.

18. The electronic system of claim 17, wherein the response message includes at least one of the one or more system records.

19. The electronic system of claim 17, wherein the computer program product further comprises instructions for causing the processor to:
send the response message to a computer system that sent the service request.

20. The electronic system of claim 15, wherein the computer program product further comprises instructions for causing the processor to:
retrieve one or more system records pertaining to the service request; and
send to a computer system used by the qualified type of service provider the one or more system records and the service request.
